(19) United States
(12) Patent Application Publication
(10) Pub. No.: US 2009/0134675 A1
(43) Pub. Date: May 28, 2009

(54) Motor Vehicle Seat Provided With a Ventilation Device

(75) Inventor: Karl Pfahler, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: Daimier AG, Stuttgart (DE)

(21) Appl. No.: 11/996,632

(22) PCT Filed: Jul. 26, 2006
(86) PCT No.: PCT/EP06/07381

§ 371 Date: Jul. 11, 2008

(30) Foreign Application Priority Data
Jul. 27, 2005 (DE) 10 2005 035 116.6

(51) Int. Cl. B60N 2/56; B60H 1/00; A47C 7/74

(52) U.S. Cl. 297/180.1; 454/120

(57) ABSTRACT

The backrest and/or seat cushion part of a motor vehicle seat include/includes padding with a ventilation device including a ventilation layer and a device for heating and/or cooling the air flowing through the ventilation layer. The padding can be heated and/or cooled by the ventilation device in an improved manner by a warm or cold air flow for heating the seat or ventilating the seat. The heating and/or cooling device forms a sandwich with at least one heating and/or cooling layer and at least one air-permeable layer. The air-permeable layer has a structure by which the air flow can be converted into a turbulent and/or diffuse flow.

### BACKGROUND AND SUMMARY OF THE INVENTION

This invention relates to a motor vehicle seat in which at least one of the backrest and the seat cushion thereof includes padding with a ventilation device.

Such a motor vehicle seat is already known from German document DE 100 54 008 B4, in which in addition to an air supply device for supplying the head, shoulder and neck region of the seat occupant with preferably warm air, a ventilation device is also incorporated in the padding of the backrest and/or the seat cushion. This ventilation device comprises a large-surfaced ventilation layer, in which air for ventilating the padding is able to circulate. The air generated by means of a fan is thus supplied via a duct to the ventilation layer. According to whether the padding is intended to be permeated with warm or with cold air, the air may be conditioned by means of a heating and/or cooling device arranged downstream of the fan.

In further vehicle seats known from German documents DE 196 28 698 C1 and DE 197 03 516 C1, ventilation devices are provided in the padding thereof. In each configuration, via a plurality of small fans, air is delivered into a ventilation layer which circulates from the air inlet to an air outlet of the ventilation layer. Moisture secreted by the seat occupant thus passes through the perforations of the seat cover and moisture-permeable supporting layers arranged thereunder as far as the ventilation layer, where the moisture is transported out of the ventilation layer by means of the air flow in the direction of the air outlet openings.

The object of the present invention is to improve a motor vehicle seat of the aforementioned type, such that an air flow which flows through the padding of the backrest and/or the seat cushion may be heated and/or cooled in an improved manner by means of the heating and/or cooling device.

This object is achieved according to the invention by a motor vehicle seat with the features claimed. Advantageous embodiments and useful, non-trivial developments of the invention are also claimed.

The heating and/or cooling device comprises a sandwich formed from at least one heating and/or cooling layer and at least one air-permeable layer. The air-permeable layer, according to the invention, is provided with a structure by means of which the air flow entering the sandwich may be converted into a turbulent and/or diffuse flow. Such a turbulent and/or diffuse flow has the advantage that the flow may absorb considerably more heat and/or cold than laminar air. In contrast to a laminar flow, in the present case, the boundary layers coming directly into contact with a corrugated rib, for example, are heated/cooled, and a considerably greater proportion of air is heated/cooled as well. Moreover, the turbulent and/or diffuse flow produced causes the air flow to remain longer within the air-permeable layer, so that more heat and/or cold may be absorbed.

As a result, due to the structure of the sandwich according to the invention, the heating and/or cooling capacity required for the heating and/or cooling of the air flow which flows through may be considerably reduced relative to the heating and/or cooling devices known from the prior art. A further advantage of the structure according to the invention is that by the improved heat and/or cold output to the air flow which flows through, the heating and/or cooling device may be considerably reduced in its geometric dimensions.

A particularly space-saving arrangement of the sandwich of the heating and/or cooling device is provided if the heating and/or cooling device is arranged directly inside the ventilation layer. If the sandwich, therefore, is at least approximately adapted in its thickness to that of the ventilation layer, inside the padding layer bearing the ventilation layer—which frequently is formed from a foamed material—no separate recess for the sandwich of the heating and/or cooling device needs to be provided. In a particularly simple embodiment, moreover, it is also conceivable to form the air-permeable layer of the sandwich of the heating and/or cooling device from the ventilation layer itself. In this embodiment, therefore, the heating and/or cooling layer is directly applied to a portion of the ventilation layer as an air-permeable layer. In this connection, it might even be conceivable to cover the broad side of the ventilation layer completely by a heating and/or cooling layer.

A particularly simple design of the ventilation device for the motor vehicle seat is additionally produced when the heating and/or cooling device is arranged inside an otherwise present air duct, preferably an air inlet duct for the ventilation layer. With this incorporation of the sandwich of the heating and/or cooling device in the air inlet duct, hardly any structural alterations are necessary. The heating and/or cooling device may fill up the entire cross section of the air duct and thus produce very effective heating and/or cooling of the air.

With the incorporation of the heating and/or cooling device in the air inlet duct, the seat may be easily retrofitted. Thus, for example, the seat may be produced without the heating and/or cooling device, and the heating and/or cooling device is configured as a module which is adapted to the cross section of the air duct and is configured to be retrofitted.

For accurate control of the heating and/or cooling device, a temperature sensor may be arranged downstream of the heating and/or cooling device, which is connected to a control unit for controlling the heating and/or cooling device. The temperature sensor may be arranged in an air duct downstream of the heating and/or cooling device or, to simplify the retrofitting, may already be incorporated in the heating and/or cooling device configured as a module.

The turbulent and/or diffuse flow of the air flow is, in particular, achieved by the structure of the air-permeable layer comprising a plurality of spacer threads, spacer webs, spacer wires or the like. A conceivable design of the air-permeable layer of the sandwich is, for example, known from German document DE 198 05 178 C2, which relates to a knitted spacer fabric in a ventilated vehicle seat and reference is thus expressly made to the contents thereof. The knitted spacer fabric at that point comprises a plurality of spacer webs and/or spacer threads which extend transversely to the outer broad sides of the knitted spacer fabric and around which a turbulent and/or diffuse air flow is able to circulate. The spacer webs and/or spacer threads are thus arranged relative to one another in specific patterns, as a result of which the flow direction and flow velocity may be influenced. In this connection, it is noteworthy that the spacer webs and/or spacer threads may have very different cross-sectional shapes, such as for example circular, oval, rectangular, square or the like. The spacer webs and/or spacer threads may thus be aligned oriented or unoriented to one another, and consist of very different materials. It has proved particularly advantageous to configure the spacer webs and/or spacer threads as knitted fabric, woven fabric or as braid. Similarly, it is, however, conceivable to arrange the spacer threads and/or spacer webs unoriented in the manner of wool. It may be seen that such a knitted fabric, woven fabric or braid relative to the prior art additionally has a greater overall surface which is circulated with air for dissipating heat/cold to the air flowing through.

It has shown to be particularly advantageous to produce the structure of the air-permeable layer from a metal having good conductivity such as, for example, an aluminum or copper alloy. Such metal threads are particularly well suited for dissipating heat and/or cold to the circulating air. As a result of the large surface of the plurality of spacer threads, spacer wires and/or spacer webs which is circulated with air, a very effective heating and/or cooling device may thus be produced.

An aforementioned structure made up of spacer webs, spacer wires or spacer threads has additionally the advantage that the spacer webs, spacer wires or spacer threads may be configured to be elastically resilient. As a result, it is possible to adapt the air-permeable layer and/or the entire sandwich made up of the heating and/or cooling layer and air-permeable layer in a correspondingly simple manner to the constructional space—for example the air inlet duct of the ventilation layer. In this connection, it has proved particularly advantageous to configure the heating layer as resistance heating in the form of a thin-layered, deformable and preferably elastic layer. Also, such a thin-layered, deformable and preferably elastic cooling layer is conceivable—either alone or in combination with the heating layer.

A particularly high heating capacity of the heating layer and/or cooling capacity of the cooling layer may be achieved when a covering layer having good heat and/or cold conductivity is associated therewith, by means of which the heat/cold produced is evenly distributed inside the heating or cooling layer. In this case, in particular a metal film or a metal sheet, for example made of an aluminum or copper alloy, has been shown to be suitable.

A particularly effective sandwich of the heating and/or cooling device is produced by at least three air-permeable layers being provided, with one heating and/or cooling layer being arranged between the central and the external air-permeable layers. The central middle air-permeable layer is thus provided with heat and/or cold from both these flanking heating and/or cooling layers, so that the air flow which flows through the central layer may be particularly rapidly heated and/or cooled. The two outer air-permeable layers are accordingly only supplied with heat and/or cold by the adjacent heating and/or cooling layer, so that in this region reduced heating and/or cooling of the air flow which flows through said outer air-permeable layers results. Consequently, there is no overheating of the components surrounding the sandwich, such as for example a housing or further parts adjacent thereto.

With a plurality of layers combined to form a sandwich, the flow resistance thereof may be additionally designed to be variable, for example by the spacing and orientation of the individual spacer webs, spacer wires or spacer threads of each layer being variable.

In the simplest embodiment, the sandwich made up of the heating and/or cooling layer and the air-permeable layer is of planar design. In this case, the number of air-permeable layers and the heating and/or cooling layer arranged therebetween may be selected and/or extended in any manner. The sandwich may also have any external dimensions. Moreover, the sandwich made up of the air-permeable layer and the heating and/or cooling layer may also be substantially spiral-shaped and may be configured to be able to be extended to any diameter in cross section.

Further advantages, features and details of the invention are revealed from the following description of preferred embodiments and with reference to the drawings.

### BRIEF DESCRIPTION OF THE DRAWINGS

FIG. 1 shows a schematic sectional view along the central longitudinal plane of a motor vehicle seat with a seat cushion and a backrest, the padding thereof being provided with a ventilation device;

FIG. 2 shows an enlarged schematic sectional view of the detail II in FIG. 1 through the seat padding with a sandwich of the heating and/or cooling device of the ventilation device arranged inside the ventilation layer;

FIGS. 3a and 3b show respectively a schematic sectional view of the sandwich of the heating and/or cooling device of the ventilation device;

FIGS. 4a and 4b show respectively an enlarged schematic sectional view through the seat padding according to FIG. 2, the sandwich being arranged inside an air inlet duct for the ventilation layer—in one case enclosed by the seat cushion, in the other case under the seat cushion;

FIG. 5a shows a schematic perspective view of the sandwich made up of the air-permeable layer and the heating and/or cooling layer, which is wound in a substantially spiral-shaped manner and is arranged inside the air inlet duct of the ventilation layer;

FIGS. 5b and 5c show respectively a schematic cross section through the circular and/or oval sandwich, in which a central air-permeable layer is peripherally surrounded by a heating and/or cooling layer as well as by a further air-permeable layer;

FIGS. 6a and 6b show a plan view and a sectional view along the line VIb-VIb in FIG. 6a, respectively, through the structure of the air-permeable layer;

FIGS. 7a and 7b show a plan view and a sectional view along the line VIIb-VIIb in FIG. 7a through the structure of the air-permeable layer, respectively, according to a second embodiment;

FIGS. 8a and 8b show a schematic plan view and a schematic sectional view along the line VIIIb-VIIIb in FIG. 8a through the structure of the air-permeable layer, respectively, according to a third embodiment;

FIG. 9 shows a schematic plan view of the structure of the air-permeable layer according to a fourth embodiment; and

FIGS. 10a and 10b show a schematic plan view and a sectional view along the line Xb-Xb in FIG. 10a through the structure of the air-permeable layer, respectively, according to a fifth embodiment.

### DETAILED DESCRIPTION OF THE INVENTION

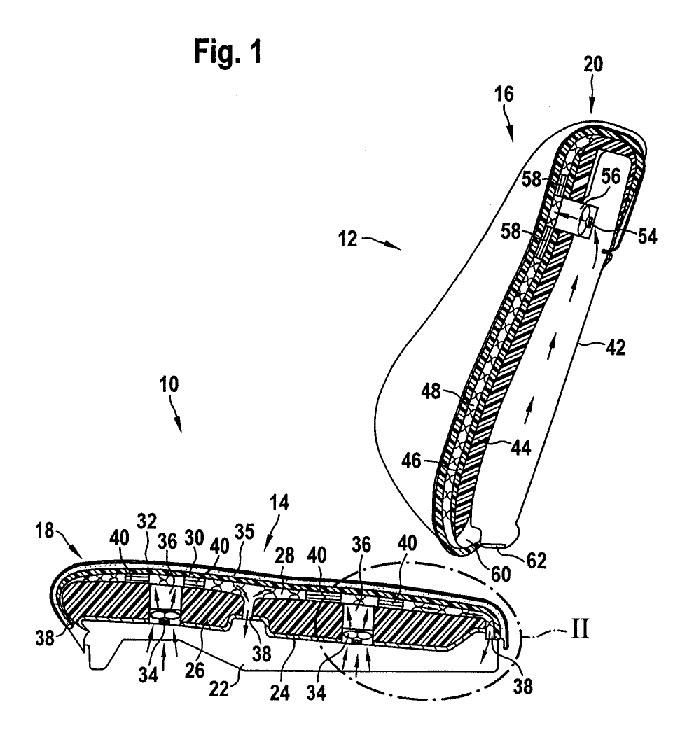

In FIG. 1 a motor vehicle seat, which comprises a seat cushion part 10 and a backrest 12, is shown in schematic sectional view along its longitudinal plane. The seat cushion part 10 and the backrest 12 respectively comprise in the present embodiment one ventilation device 14 and/or 16, which is incorporated in the respective padding 18 and/or 20. The seat cushion part 10 comprises a seat frame 22, not shown in more detail, with a padding supporting shell 24 formed, for example, from a synthetic material, on which a lower padding layer 26 rests as a lowermost layer of the padding. The lower padding layer 26 is, in the present embodiment, formed from a foamed material and extends over the entire length and width of the padding supporting shell 24. On the lower padding layer 26 rests a ventilation layer 28 of the ventilation device 14, which in the present embodiment also extends approximately over the entire length of the seat cushion part 10 and/or the padding supporting shell 24. So that air, in a manner not described in more detail hereinafter, may circulate and/or flow inside the ventilation layer, the ventilation layer in the present embodiment is formed from a wide-meshed knitted spacer fabric, such as for example is known from German document DE 198 05 178 C2. A pressure distribution layer 30 is located on the ventilation layer 28, which may consist of a non-woven material or an open-pore foamed material and is configured to be moisture-permeable. A padding cover 32, which in the present embodiment consists of leather and is uniformly perforated is stretched over the surface of the padding 18 of the seat cushion part 10 facing the seat occupant. A cover filling 35 made up of a thin foamed material or the like may be incorporated between the padding cover 32 and the pressure distribution layer 30.

In the present embodiment, the ventilation device 14 of the seat cushion part 10 comprises four miniature fans 34, of which two can be seen in FIG. 1. The fans 34 are arranged in a respectively associated air inlet duct 36 for the ventilation layer 28, the two air inlet ducts 36 being substantially formed from a cylindrical recess in the lower padding layer 26. Openings adapted to the air inlet ducts 36 are cut out of the padding support shell 24. In this case, the fans 34 are arranged at the lower end of the respectively associated air inlet duct 36. Air is drawn in via the fans 34 from below the seat cushion part 10 and blown in via the air inlet ducts 36 into the ventilation layer 28—as indicated by the arrows. The air blown in by means of the fans 34 flows through the ventilation layer 28 from the air inlet ducts 36 to the air outlet ducts 38, which in the present embodiment are provided at the front and rear end of the padding 18 of the seat cushion part 10. The relatively dry air blown in by means of the fans 34 into the ventilation layer 28, therefore, absorbs along its path as far as the air outlet openings 38 moisture from the seat occupant, which reaches the ventilation layer 28 via the perforations inside the padding cover 32, via the moisture-permeable pressure distribution layer 30 and possibly via the cover filling 35 between the pressure distribution layer 30 and the padding cover 32. In other words, therefore, the air circulating inside the ventilation layer is used for transporting away the moisture secreted by the seat occupant, in order to provide pleasant seating conditions for the seat occupant. In the vicinity of the air inlet ducts 36, the ventilation device 14 in the present embodiment comprises a plurality of heating and/or cooling devices 40 of which the mode of operation and construction is explained in more detail below. By means of the heating and/or cooling devices 40, the air circulating inside the ventilation layer 28 may be set to a temperature desired by the seat occupant. Depending on the desired setting—the padding 18, 20 as a whole is warmed or cooled as a result of cooler or warmer air. From the backrest 12, a rear cladding part 42 is substantially visible, which is retained by a backrest carrier, not shown, and is arranged at a distance behind the padding 20. The padding 20 consists substantially of a rear padding layer 44 made of foamed material, rubberized hair or the like, a cover layer 46 arranged in front, also made of foamed material, a ventilation layer 48 arranged thereon, made of a wide-meshed knitted spacer fabric or the like, a further cover layer 50 arranged thereover made of foamed material or non-woven material, as well as a padding cover 52 facing the seat occupant. In the upper region of the backrest 12 a fan 54 may be seen, which is arranged at the end of an air inlet duct 56. Via the air inlet duct 56 already explained in connection with the seat cushion part 10, air may be blown in turn into the ventilation layer 48, in this case in the vicinity of the air inlet duct 56 a heating and/or cooling device 58 also being provided for conditioning the air flowing into the ventilation layer 42. The air entering through the ventilation layer 42 may emerge again from the backrest 12 via air outlet openings 60 at the lower end of the backrest 12. The air suction takes place in the present embodiment via the intermediate space between the rear cladding part 42 and the padding 20, at the lower end of the cladding part 42 an air inlet opening 62 being able to be seen.

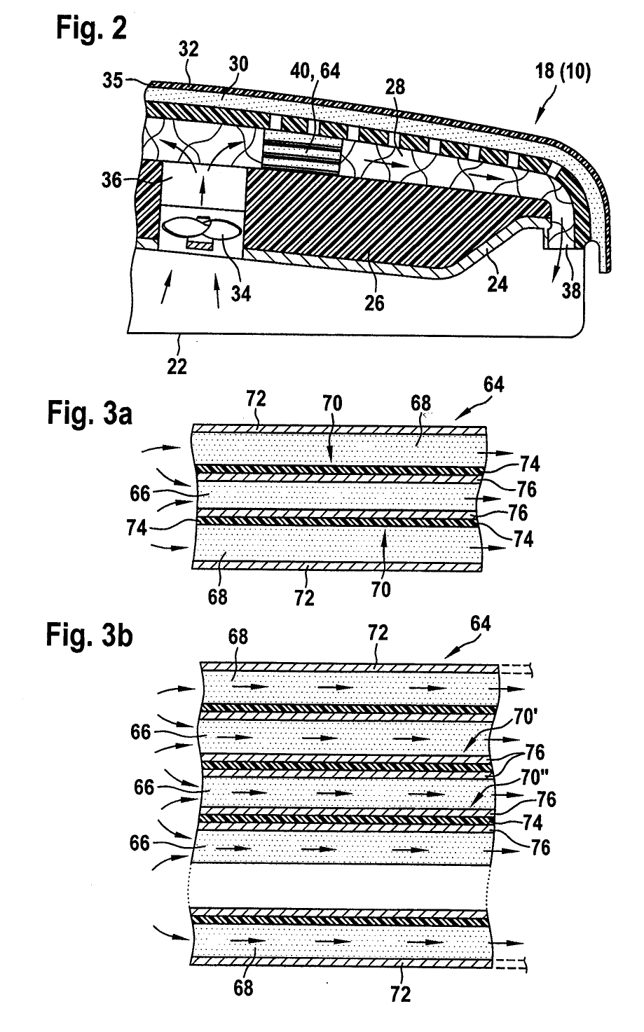

In FIG. 2, in an enlarged schematic sectional view, the detail II of FIG. 1 is shown, from which in particular the incorporation of the heating and/or cooling device 40 inside the ventilation layer 28 of the padding 18 of the seat cushion part 10 is visible. In particular it is visible that the heating and/or cooling device 40 comprises a sandwich 64, the construction thereof being clear when viewed in combination with FIGS. 3a and 3b.

FIG. 3a shows a schematic sectional view of the sandwich 64 of the heating and/or cooling device 40 which in the present embodiment, however, is merely designed as a heating device. The sandwich 64 is, in the present case, formed by a central air-permeable layer 66, two outer air-permeable layers 68 as well as two heating layers 70 described in more detail below. Instead of or additionally to the heating layers 70, cooling layers formed in a similar manner may also be used, in order to implement in addition to the heating function a cooling function of the ventilation device 14. The sandwich 64 is peripherally—i.e. with the exception of the air inlet and the air outlet side—enclosed by a housing 72 which preferably consists of a synthetic material. The sandwich 64 may alternatively also be made without the housing 72 and be arranged in the ventilation layer 28. The air flow produced by means of the fan 34 flows through the three air-permeable layers 66, 68. The heating layer 70 arranged between the central air-permeable layer 66 and the respectively associated outer air-permeable layer 68, respectively comprises resistance heating which may be supplied with electrical current and in the present case is configured as a thin-layered, deformable and elastic layer 74. A layer configured as a cooling layer could be formed in a similar manner—for example provided with Peltier elements. A covering layer 76 having good heat conductivity is associated with the two heating layers 70, which respectively are attached to the broad side of the central air-permeable layer 66 and preferably are produced from a metal film or a metal sheet having good heat conductivity, in particular made of an aluminum or copper alloy. All layers 66, 68, 74, 76 are, in the present embodiment, configured to be planar and to rest closely against one another.

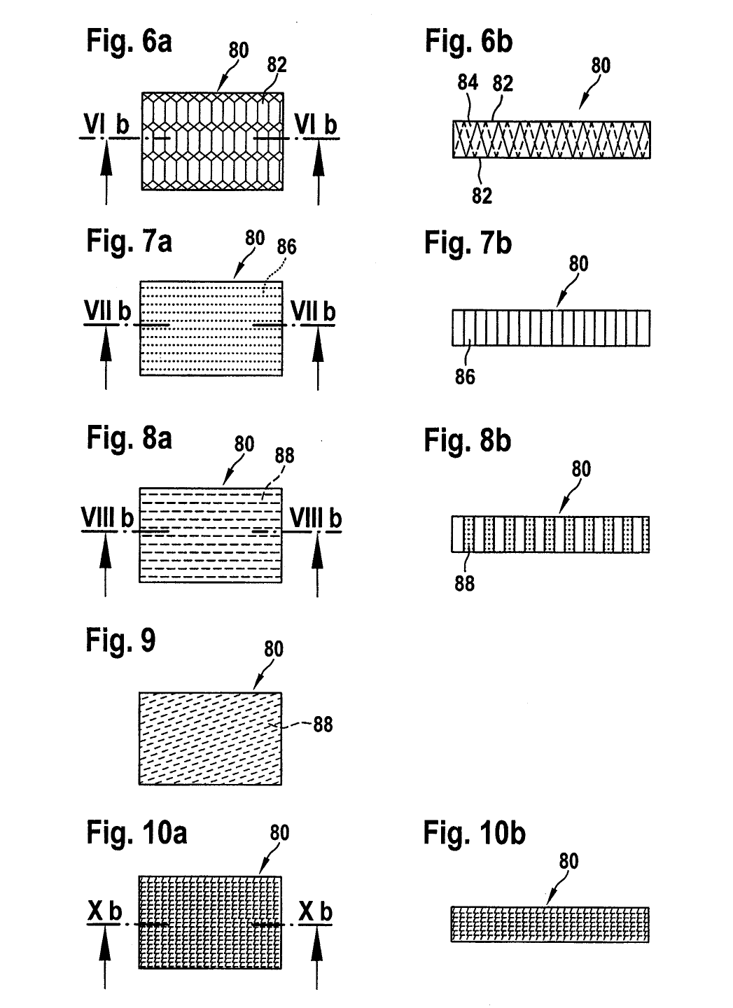

If an air flow is produced by the fan 34 mounted upstream of the sandwich 64, said air flow enters the central air-permeable layer 66 via the respective narrow side of the sandwich 64, as well as the two outer air-permeable layers 68. The three air-permeable layers 66, 68 are, in the present embodiment, produced from a knitted spacer fabric described in more detail below with reference to FIGS. 6a and 6b, which consists of a plurality of spacer threads and/or spacer webs. The spacer threads and/or spacer webs extend in this case substantially transversely to the flow direction of the air flow and/or transversely to the broad sides of the air-permeable layers 66, 68. Instead of such a knitted spacer fabric, a woven fabric, braid or wool-type pattern produced from a plurality of spacer threads or the like may also be used. In other words, the spacer webs and/or spacer threads may be arranged oriented relative to one another or else—such as is usual with wool—be unoriented relative to one another. An air flow produced by the fan 34, when flowing through the respective air-permeable layer 66, 68 is thus accordingly frequently deflected onto the spacer threads and/or spacer webs and a turbulent diffuse flow is already established within the respective air-permeable layer 66, 68 after a short path. Relative to a laminar flow, said diffuse flow produced by the spacer threads and/or spacer webs remains longer inside the associated air-permeable layer 66, 68 and may accordingly absorb more heat (and/or cold with a cooling layer) via the heating element 70—consisting of the resistance heating layer 74 and the covering layer 76. The diffuse distribution of the air flow inside the respective air-permeable layer 66, 68 also has the result that not only individual boundary layers come into contact with the respective heating layer 70, but additionally an efficient and uniform distribution is achieved by mixing the air flow.

Due to the fact that the two outer air-permeable layers 68 respectively only come into contact with the heating layer 14 and/or the resistance heating layer 74 thereof on their broad side facing the central layer 66, if required, the two air flows passing through the respective outer air-permeable layer 68 may be heated less (and/or with a cooling layer 14 cooled less) than the air flow passing through the central air-permeable layer 66. As a result, the peripheral layers of the ventilation layer 28 are not subjected to such high temperatures as a central region. In other words, the two partial air flows which flow through the air-permeable layers 68 act as a kind of heat insulator for the central, warmer partial air flow.

Additionally, the central air-permeable layer 66 may have a higher flow resistance than the two outer air-permeable layers 68 flanking said layer. The higher flow resistance is achieved by the spacer threads and/or spacer webs of the central air-permeable layer 66 being arranged more closely together, and thus the knitted fabric or woven fabric as a whole is formed to be more tightly meshed and/or more dense than the structure of the two outer air-permeable layers 68. As a result,—with the same inlet velocity of all air flows at the inlet side of the air-permeable layers 66, 68—it is achieved that the partial air flow through the central layer 66 flows through said central layer more slowly than the two partial air flows which pass through the two outer layers 68. As a result of different velocities, accordingly, more or less heat (and/or cold in a cooling layer) may be absorbed by the individual air flows. Moreover, on the outlet side an optionally desired layering of the entire air flow may be achieved, namely with a central warmer air flow and two outer, slightly less warm air flows.

FIG. 3b shows in schematic sectional view a further embodiment of the sandwich 64. As indicated in dotted lines, the sandwich 64 is therefore able to be extended by one or more central air-permeable layers 66, and thus may be variable in its thickness. Three central layers 66 as well as one respective outer layer 68 on the outside are arranged in the embodiment shown here, respectively at least one heating and/or cooling layer 70 being provided between the individual layers 66, 68. The sandwich 64 is thus in turn arranged inside a housing 72. Whilst in FIG. 3b the uppermost heating layer 70 is identical to the uppermost heating layers 70 according to FIG. 3a, the second uppermost and third uppermost heating layer 70′, 70″, viewed from above, respectively have a different construction. In the second uppermost heating layer 70′, directly attached to the central layer 66 located thereabove and/or thereunder, one respective covering layer 76 is provided which, in turn, is produced from a metal sheet or a metal film having good heat conductivity. One resistance heating layer 74 is respectively associated with each of the two covering layers 76. The construction of the third uppermost heating layer 70″ differs from this construction of the second uppermost heating layer 70′, in that instead of two resistance heating layers 74, only one is arranged between the two covering layers 76, and thus heats said two covering layers 76.

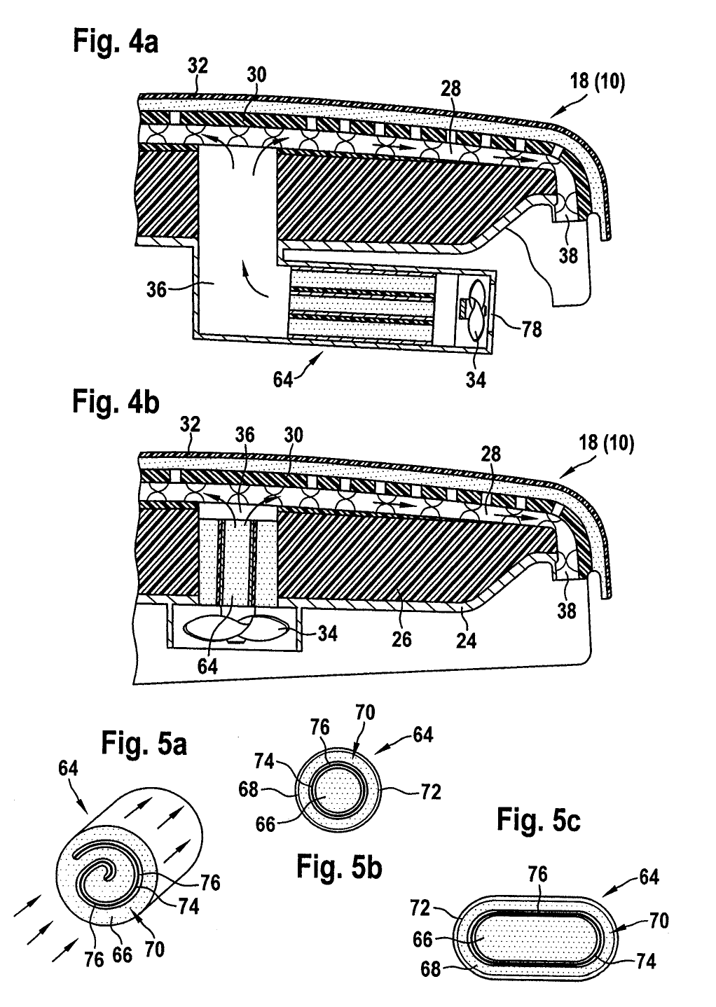

FIG. 4a shows an enlarged schematic sectional view through the padding 18 of the seat cushion part 10, the sandwich 64 inside the air inlet duct 36 being associated with the ventilation layer 28. To this end, the air inlet duct 36 is laterally and downwardly moved out of the padding 18. As a whole, the air inlet duct 36 describes an approximately L-shaped tubular connector. At the free end of the air inlet duct remote from the padding 18 the fan 34 is provided which may be supplied with fresh air via an opening 78 in the air duct 36. The sandwich 34 is designed according to that of FIGS. 2 and 3a and thus does not need to be described in more detail. After flowing through the sandwich 64, the air flow produced by means of the fan 34—as indicated by the arrows—enters the ventilation layer 28 and spreads out there in all directions toward the air outlet openings 38. In order to achieve good controllability, it may be provided that a temperature sensor not shown in FIG. 4, and known per se, is arranged downstream of the sandwich 64 which measures the temperature of the air flow and forwards said temperature to a control unit.

FIG. 4b also shows an enlarged schematic section through the padding 18 of the seat cushion part 10, a sandwich 64 formed for example according to FIGS. 5a and 5b being arranged inside the air inlet duct 36 of the ventilation layer 28. In other words, the sandwich 64 of the heating and/or cooling device 40 is arranged inside the air inlet duct 36 formed by the recess in the padding supporting part 24 and in the lower padding layer 26 and thus enclosed by the padding layer 26. The fan 34 is thus fastened to the underside of the padding supporting part 24.

FIG. 5a shows in a schematic perspective view the sandwich 64 which is arranged inside the air inlet duct 36. The sandwich 64 consists substantially of a heating layer 70 and an air-permeable layer 66 and is wound to form an approximately circular spiral in cross section. The air-permeable layer 66 is configured such that said air-permeable layer entirely encloses peripherally the heating layer 70. The heating layer 70 consists in turn of a resistance heating layer 74 which at both its broad sides is covered respectively by a covering layer 76, preferably made of a metal film or a metal sheet. It may be seen that also in this case central portions of the air-permeable layer 66 at both their broad sides are flanked by the heating layer 70. In these regions accordingly, a powerful heating of the air flow is possible.

Accordingly, the portion of the air flow which flows through the external regions of the air-permeable layer 66, is less powerfully heated than the aforementioned internal parts of the entire air flow. As a result, therefore, a layering of the entire air flow is also possible—viewed in cross section, a central partial air flow being more powerfully heated than an external portion of the air flow. It is clear that the air-permeable layer 30 may also comprise a plurality of portions which have a variable flow resistance. Additionally, in this case a cooling layer may also be provided instead of or additionally to the heating layer 70.

In FIGS. 5b and 5c respectively the sandwich 64 is shown in a schematic cross-sectional view. The sandwich 64 in this case comprises a central air-permeable layer 66 which as a whole is approximately circular and/or oval in cross section and which is peripherally surrounded by a heating layer 70. The heating layer 70 comprises a covering layer 76 attached to the outer peripheral side of the air-permeable layer 66, made of metal sheet or metal film, which in turn is externally enclosed by a resistance heating layer 74. On the external periphery of the heating layer 70, an external air-permeable layer 68 is provided.

In FIGS. 6a and 6b, in schematic plan view and in schematic sectional view along the line VIb-VIb in FIG. 6a, a possible structure 80 of the air-permeable layers 66, 68 is shown. The structure 80 consists in this case of a so-called knitted spacer fabric which at its upper and lower broad side encompasses one respective covering layer in the form of a honeycombed structure. Between the upper and lower covering layer 82 extend a plurality of spacer threads and/or spacer webs 84, which extend substantially transversely to the two covering layers 82. By the orientation and the spacing of the spacer threads and/or spacer webs 84 to one another, in this case the flow resistance of the structure 80 may be varied and accordingly the flow velocity of the air flow passing through the structure 80 may be set. In the present embodiment, the spacer threads or spacer webs 44, in particular, may be made from a synthetic material. In a particular embodiment, instead of the spacer threads or spacer webs 84, spacer wires or the like are also used, which preferably are produced from a metal having good heat conductivity such as an aluminum alloy or a copper alloy. Such metal wires have the advantage relative to synthetic threads in that said metal wires are also able to raise the temperature of the heat and/or cold—produced by means of the heating and/or cooling layer 40—particularly easily in the turbulent and/or diffuse flow of the air flow.

In FIGS. 7a and 7b, in schematic plan view and in a schematic layered view along the line VIIb-VIIb in FIG. 7a, the structure 80 of the air-permeable layers 66, 68, according to a further embodiment, is shown. In this case, the spacer webs and/or spacer wires 86 extend perpendicular to the two broad sides of the structure 80. The spacer webs and/or spacer wires 86 are in this case—as is visible from FIG. 7a—arranged in rows relative to one another.

In FIGS. 8a and 8b, in schematic plan view and in schematic sectional view along the line VIIIb-VIIIb in FIG. 8a, a further structure 80 is shown in which, between the two broad sides of the structure 80, spacer webs 88 extend with a substantially rectangular cross section. As is visible by viewing together with FIG. 9, which in plan view shows the arrangement of the spacer webs 88 in an alternative embodiment, it may be seen that the webs may be aligned longitudinally, transversely or, however, obliquely to the flow direction of the air flow which flows through the air-permeable layer.

Finally, FIGS. 10a and 10b, in schematic plan view and in sectional view along the line Xb-Xb in FIG. 10a, a structure 80 is shown in which the spacer threads, spacer webs or spacer wires are aligned unoriented to one another in the manner of wool. The spacer threads, spacer webs or spacer wires may, in this case in particular, be produced from a synthetic material or else from a metal.

1-15. (canceled)

16. A motor vehicle seat, comprising:
a back rest,
a seat-cushion part, and
padding with a ventilation device,
wherein said padding with said ventilation device comprises a ventilation layer and an adjustment device for heating and/or cooling air flowing through the ventilation layer,
wherein the adjustment device forms a sandwich including at least one heating and/or cooling layer and at least one air-permeable layer, and
wherein the air-permeable layer has a structure by which the air flow is convertable into a turbulent flow and/or a diffuse flow.

17. The motor vehicle seat as claimed in claim 16, wherein the adjustment device is arranged inside the ventilation layer and the sandwich is at least approximately adapted in its thickness to the ventilation layer.

18. The motor vehicle seat as claimed in claim 16, wherein the adjustment device is arranged inside an air inlet duct of the ventilation layer.

19. The motor vehicle seat as claimed in claim 18, further comprising a temperature sensor arranged downstream of the adjustment device.

20. The motor vehicle seat as claimed in claim 19, wherein the adjustment device is enclosed by a padding layer and is arranged inside the air inlet duct of the ventilation layer.

21. The motor vehicle seat as claimed in claim 19, wherein the adjustment device is arranged inside a duct portion of the air inlet duct of the ventilation layer that is arranged outside a padding layer of the padding.

22. The motor vehicle seat as claimed in claim 16, wherein the air-permeable layer has a structure comprising a plurality of spacer threads, spacer webs, or spacer wires.

23. The motor vehicle seat as claimed in claim 16, wherein the air-permeable layer has a structure formed from a knitted fabric.

24. The motor vehicle seat as claimed in claim 16, wherein the air-permeable layer has a structure formed from a woven fabric.

25. The motor vehicle seat as claimed in claim 16, wherein the air-permeable layer has a structure formed from a braid.

26. The motor vehicle seat as claimed in claim 16, wherein the air-permeable layer has a structure that is designed to be unoriented.

27. The motor vehicle seat as claimed in claim 26, wherein the air-permeable layer is wool.

28. The motor vehicle seat as claimed in claim 26, wherein the air-permeable layer is a metal wool.

29. The motor vehicle seat as claimed in claim 16, wherein the air-permeable layer has a structure that is configured to be slightly deformable.

30. The motor vehicle seat as claimed in claim 16, further comprising a covering layer having good thermal conductivity associated with the heating and/or cooling layer that is arranged between the heating and/or cooling layer and the air-permeable layer.

31. The motor vehicle seat as claimed in claim 16, wherein the at least one heating and/or cooling layer is arranged between central and external air-permeable layers.

32. The motor vehicle seat as claimed in claim 31, wherein the air-permeable central layer has a higher flow resistance than the external air-permeable layer.
